(19) United States
(12) Patent Application Publication
(10) Pub. No.: US 2019/0193464 A1
(43) Pub. Date: Jun. 27, 2019

(54) TREAD RUBBER COMPOSITION AND PNEUMATIC TIRE

(71) Applicant: SUMITOMO RUBBER INDUSTRIES, LTD., Hyogo (JP)

(72) Inventor: Kenji HAMAMURA, Hyogo (JP)

(73) Assignee: SUMITOMO RUBBER INDUSTRIES, LTD., Hyogo (JP)

(21) Appl. No.: 16/219,181

(22) Filed: Dec. 13, 2018

(30) Foreign Application Priority Data
Dec. 27, 2017 (JP) 2017-251830

(51) Int. Cl. B60C 1/00; C08L 9/06; C08L 47/00

(52) U.S. Cl. CPC B60C 1/0016; C08L 9/06; C08K 5/47; B60C 2200/04; C08L 47/00

(57) ABSTRACT

Provided is a tread rubber composition satisfying the following relationships (1) and (2):

|(−20° C. E*)−(0° C. E*)|≤40 [MPa] (1)

wherein “−20° C. E*” denotes the complex modulus measured at a temperature of −20° C., an initial strain of 10%, a dynamic strain of 0.5%, and a frequency of 10 Hz, and “0° C. E*” denotes the complex modulus measured at a temperature of 0° C., an initial strain of 10%, a dynamic strain of 0.25%, and a frequency of 10 Hz; and

0° C. tan δ/30° C. tan δ≤3.0 (2)

wherein “0° C. tan δ” denotes the loss tangent measured at a temperature of 0° C., an initial strain of 10%, a dynamic strain of 2.5%, and a frequency of 10 Hz, and “30° C. tan δ” denotes the loss tangent measured at a temperature of 30° C., an initial strain of 10%, a dynamic strain of 2%, and a frequency of 10 Hz.

### TECHNICAL FIELD

The present invention relates to a tread rubber composition and a pneumatic tire.

### BACKGROUND ART

The materials of cold weather tires (winter tires) and all season tires have been designed with low temperature properties in mind. For example, Patent Literature 1 proposes rubber compositions containing a specific. resin.

### CITATION LIST

### Patent Literature

Patent Literature 1: JP 2013-249423 A

### SUMMARY OF INVENTION

### Technical Problem

In Patent Literature 1, the rubber compositions are evaluated for performance on ice and snow at −10° C. to −1° C. However, as tires have been used in a wider range of environments in recent years, they may in some situations be used at temperatures lower than those mentioned above. Under such circumstances, the present inventor studied to improve the performance at lower temperatures and found that some rubber compositions have good abrasion resistance at room temperature but exhibit insufficient abrasion resistance at temperatures as low as −20° C.

The present invention aims to solve the problem and provide a tread rubber composition that provides improved abrasion resistance at −20° C., and a pneumatic tire including a tread at least partially containing the rubber composition.

### Solution to Problem

The present invention relates to a tread rubber composition, satisfying the following relationships (1) and (2):

|(−20° C. E*)−(0° C. E*)|≤40 [MPa] (1)

wherein the term “−20° C. E*” denotes a complex modulus measured at a temperature of −20° C., an initial strain of 10%, a dynamic strain of 0.5%, and a frequency of 10 Hz, and the term “0° C. E*” denotes a complex modulus measured at a temperature of 0° C., an initial strain of 10%, a dynamic strain of 0.25%, and a frequency of 10 Hz; and

0° C. tan δ/30° C. tan δ≤3.0 (2)

wherein the term “0° C. tan δ” denotes a loss tangent measured at a temperature of 0° C., an initial strain of 10%, a dynamic strain of 2.5%, and a frequency of 10 Hz, and the term “30° C. tan δ” denotes a loss tangent measured at a temperature of 30° C., an initial strain of 10%, a dynamic strain of 2%, and a frequency of 10 Hz.

The |(−20° C. E*)−(0° C. E*)| value in relationship (1) is preferably 30 MPa or less, more preferably 20 MPa or less.

Preferably, the rubber composition contains styrene butadiene rubber and polybutadiene rubber, and the styrene butadiene rubber has a styrene content of 25 to 40% by mass and a vinyl content of 40 to 55% by mass.

The polybutadiene rubber is preferably a modified polybutadiene rubber.

Another aspect of the present invention relates to a pneumatic tire, including a tread at least partially containing the rubber composition.

The pneumatic tire is preferably a cold weather tire or an all season tire.

### Advantageous Effects of Invention

The tread rubber composition of the present invention satisfying predetermined relationships provides improved abrasion resistance at −20° C.

### DESCRIPTION OF EMBODIMENTS

The tread rubber composition of the present invention satisfies the following relationships (1) and (2):

|(−20° C. E*)−(0° C. E*)|≤40 [MPa] (1)

wherein the term “−20° C. E*” denotes the complex modulus measured at a temperature of −20° C., an initial strain of 10%, a dynamic strain of 0.5%, and a frequency of 10 Hz, and the term “0° C. E*” denotes the complex modulus measured at a temperature of 0° C., an initial strain of 10%, a dynamic strain of 0.25%, and a frequency of 10 Hz; and

0° C. tan δ/30° C. tan δ≤3.0 (2)

wherein the term “0° C. tan δ” denotes the loss tangent measured at a temperature of 0° C., an initial strain of 10%, a dynamic strain of 2.5%, and a frequency of 10 Hz, and the term “30° C. tan δ” denotes the loss tangent measured at a temperature of 30° C., an initial strain of 10%, a dynamic strain of 2%, and a frequency of 10 Hz.

The |(−20° C. E*)−(0° C. E*)| value in relationship (1) indicates the temperature dependence of the complex modulus (E*) of the rubber composition. A value closer to 0 means less temperature-dependent E*. Likewise, the 0° C. tan δ/30° C. tan δ value in relationship (2) indicates the temperature dependence of the loss tangent (tan δ) of the rubber composition. A value closer to 1 means less temperature-dependent tan δ. When these values fall within the respective ranges, the rubber composition provides significantly improved abrasion resistance at −20° C.

The E* and tan δ values are determined by performing viscoelastic testing on the vulcanized rubber composition.

In order to obtain better abrasion resistance at −20° C., the |(−20° C. E*)−(0° C. E*)| value in relationship (1) is preferably 30 MPa or less, more preferably 20 MPa or less, still more preferably 15 MPa or less, particularly preferably 10 MPa or less, most preferably 5 MPa or less.

The lower limit of the |(−20° C. E*)−(0° C. E*)| value is not particularly critical, but is preferably closer to 0 and may be 0.

The −20° C. E* may be appropriately adjusted within a range that satisfies relationship (1) and is preferably 30 MPa or more, more preferably 40 MPa or more, but is preferably 90 MPa or less, more preferably 80 MPa or less.

Likewise, the 0° C. E* is preferably 10 MPa or more, more preferably 15 MPa or more, but is preferably 80 MPa or less, more preferably 70 MPa or less.

In order to obtain better abrasion resistance at −20° C., the 0° C. tan δ/30° C. tan δ value in relationship (2) is preferably 2.9 or less, more preferably 2.7 or less, still more preferably 2.5 or less, but is preferably 1.7 or more, more preferably 1.9 or more, still more preferably 2.1 or more.

The 0° C. tan δ may be appropriately adjusted within a range that satisfies relationship (2) and is preferably 0.50 or less, more preferably 0.40 or less, but is preferably 0.20 or more, more preferably 0.30 or more.

Likewise, the 30° C. tan δ is preferably 0.30 or less, more preferably 0.20 or less, but is preferably 0.05 or more, more preferably 0.10 or more.

The E* and tan δ of the rubber composition may be controlled by varying the types and amounts of chemicals, particularly rubber component or filler, incorporated in the rubber composition. For example, increasing the amount of filler tends to increase the E*, while using a modified rubber or silica filler tends to reduce the tan δ. Moreover, improving compatibility between a plurality of rubbers, if used as a rubber component, tends to reduce the temperature dependence of the E* or tan δ.

Chemicals that may be used in the rubber composition will be described below.

Examples of the rubber component include diene rubbers such as isoprene-based rubbers, polybutadiene rubber (BR), styrene-butadiene rubber (SBR), and styrene-isoprene-butadiene rubber (SIBR). The rubber component may include a single rubber or a combination of two or more rubbers. Among these, BR and/or SBR is preferred.

Non-limiting examples of the BR include those commonly used in the tire industry, and they may be used alone or in combinations of two or more.

The BR may be an unmodified BR but is preferably a modified BR. The use of a modified BR allows silica, which will usually be localized in the SBR phase, to be distributed in the BR phase so that the compatibility between BR and SBR can be improved.

Moreover, despite the fact that the improvement in compatibility between BR and SBR usually leads to a lower grass transition temperature (Tg) and a deteriorated balance between wet grip performance and fuel economy, the use of a modified BR can ensure good balance between these properties.

The modified BR may be any BR having a functional group interactive with a filler such as silica. For example, it may be a chain end-modified BR obtained by modifying at least one chain end of a BR with a compound (modifier) having the functional group (i.e., a chain end-modified BR terminated with the functional group); a backbone-modified BR having the functional group in the backbone; a backbone- and chain end-modified BR having the functional group in both the backbone and chain end (e.g., a backbone- and chain end-modified BR in which the backbone has the functional group and at least one chain end is modified with the modifier); or a chain end-modified BR that has been modified (coupled) with a polyfunctional compound having two or more epoxy groups in the molecule so that a hydroxyl or epoxy group is introduced thereinto. These modified BRs may be used alone or in combinations of two or more.

Examples of the functional group include amino, amide, silyl, alkoxysilyl, isocyanate, imino, imidazole, urea, ether, carbonyl, oxycarbonyl, mercapto, sulfide, disulfide, sulfonyl, sulfinyl, thiocarbonyl, ammonium, imide, hydrazo, azo, diazo, carboxyl, nitrile, pyridyl, alkoxy, hydroxyl, oxy, and epoxy groups. These functional groups may be substituted. Among these, the functional group is preferably an amino group (preferably an amino group whose hydrogen atom is replaced with a C1-C6 alkyl group) , an alkoxy group (preferably a C1-C6 alkoxy group), or an alkoxysilyl group (preferably a C1-C6 alkoxysilyl group).

The BR preferably has a weight average molecular weight (Mw) of 300,000 or more, more preferably 400,000 or more, but preferably 1,000,000 or less, more preferably 800,000 or less. A BR having a Mw falling within the range indicated above tends to have good compatibility with SBR.

The modified BR, if used, preferably has a cis content of 20% by mass or higher, more preferably 30% by mass or higher, but preferably 70% by mass or lower, more preferably 60% by mass or lower.

The unmodified BR, if used, preferably has a cis content of 80% by mass or higher, more preferably 95% by mass or higher, while the upper limit of the cis content is not particularly critical.

A modified or unmodified BR having a cis content falling within the range indicated above tends to have good compatibility with SBR.

The modified BR, if used, preferably has a vinyl content of 5% by mass or higher, more preferably 10% by mass or higher, but preferably 30% by mass or lower, more preferably 20% by mass or lower.

The unmodified BR, if used, preferably has a vinyl content of 1% by mass or higher, more preferably 2% by mass or higher, but preferably 8% by mass or lower, more preferably 5% by mass or lower.

A modified or unmodified BR having a vinyl content falling within the range indicated above tends to have good compatibility with SER.

The BR may be, for example, a product of Ube Industries, Ltd., JSR Corporation, Asahi Kasei Corporation, or Zeon Corporation.

The amount of the BR (the combined amount of the modified BR and the unmodified BR, if used in combination), if present, based on 100% by mass of the rubber component is preferably 20% by mass or more, more preferably 40% by mass or more, still more preferably 50% by mass or more, particularly preferably 55% by mass or more, but is preferably 70% by mass or less, more preferably 60% by mass or less. When the amount falls within the range indicated above, the effects of the present invention tend to be better achieved.

The amount of the modified BR, if used, based on 100% by mass of the total BR is preferably 50% by mass or more, more preferably 60% by mass or more, but is preferably 80% by mass or less, more preferably 70% by mass or less. When the amount falls within the range indicated above, the effects of the present invention tend to be better achieved.

Any SBR may be used, including, for example, those commonly used in the tire industry such as emulsion-polymerized SBR (E-SBR) and solution-polymerized SBR (S-SBR). These SERs may be used alone or in combinations of two or more.

The SBR may be an unmodified SBR or a modified SBR. Examples of the modified SBR include SBRs into which functional groups as described for the modified BR are introduced. Preferred functional groups include amino and amide groups.

The SBR may be, for example, a product manufactured or sold by Sumitomo Chemical Co., Ltd., JSR Corporation, Asahi Kasei Corporation, or Zeon Corporation.

The SBR preferably has a weight average molecular weight (Mw) of 100,000 or more, more preferably 150,000 or more, but preferably 1,000,000 or less, more preferably 800,000 or less. An SBR having a Mw falling within the range indicated above tends to have both abrasion resistance and compatibility with BR.

The SBR preferably has a styrene content of 5% by mass or higher, more preferably 10% by mass or higher, still more preferably 25% by mass or higher, but preferably 40% by mass or lower, more preferably 30% by mass or lower. An SBR having a styrene content falling within the range indicated above tends to have good compatibility with BR.

The SBR preferably has a vinyl content of 10% by mass or higher, more preferably 20% by mass or higher, still more preferably 40% by mass or higher, but preferably 60% by mass or lower, more preferably 55% by mass or lower, still more preferably 50% by mass or lower. An SBR having a vinyl content falling within the range indicated above tends to have good compatibility with BR.

The amount of the SBR, if present, based on 100% by mass of the rubber component is preferably 20% by mass or more, more preferably 40% by mass or more, still more preferably 45% by mass or more, but is preferably 90% by mass or less, more preferably 80% by mass or less, still more preferably 70% by mass or less. When the amount falls within the range indicated above, the effects of the present invention tend to be better achieved.

Herein, the weight average molecular weight (Mw) can be determined by gel permeation chromatography (GPC) (GPC-8000 series available from Tosoh Corporation, detector: differential refractometer, column: TSKGEL SUPERMULTIPORE HZ-M available from Tosoh Corporation) calibrated with polystyrene standards.

The cis content (cis-1,4-butadiene unit content) and the vinyl content (1,2-butadiene unit content) can be determined by infrared absorption spectrometry. The styrene content can be determined by ¹H-NMR analysis.

The rubber composition may contain carbon black.

Non-limiting examples of the carbon black include N134, N110, N220, N234, N219, N339, N330, N326, N351, N550, and N762. These types of carbon black may be used alone or in combinations of two or more.

The carbon black preferably has a nitrogen adsorption specific surface area (N₂SA) of 80 m²/g or more, more preferably 100 m²/g or more, but preferably 150 m²/g or less, more preferably 130 m²/g or less. When the N₂SA falls within the range indicated above, the effects of the present invention tend to be better achieved.

Herein, the N₂SA of the carbon black is measured in accordance with JIS K6217-2:2001.

The carbon black may be, for example, a product of Asahi Carbon Co., Ltd., Cabot Japan K.K., Tokai Carbon Co., Ltd., Mitsubishi Chemical Corporation, Lion Corporation, NSCC Carbon Co., Ltd, or Columbia Carbon.

The amount of the carbon black, if present, per 100 parts by mass of the rubber component is preferably 5 parts by mass or more, more preferably 10 parts by mass or more, but is preferably 50 parts by mass or less, more preferably 20 parts by mass or less. When the amount falls within the range indicated above, the effects of the present invention can be more suitably achieved.

The rubber composition may contain silica. Examples of the silica include dry silica (anhydrous silicic acid) and wet silica (hydrous silicic acid). Wet silica is preferred because it has a large number of silanol groups. These types of silica may be used alone or in combinations of two or more.

The silica preferably has a nitrogen adsorption specific surface area (N₂SA) of 120 m²/g or more, more preferably 170 m²/g or more, still more preferably 200 m²/g or more, but preferably 300 m²/g or less, more preferably 260 m²/g or less. When the N₂SA falls within the range indicated above, the effects of the present invention tend to be better achieved.

The N₂SA of the silica is measured by the BET method in accordance with ASTM D3037-81.

The silica may be, for example, a product of Degussa, Rhodia, Tosoh Silica Corporation, Solvay Japan, or Tokuyama Corporation.

The amount of the silica, if present, per 100 parts by mass of the rubber component is preferably 30 parts by mass or more, more preferably 50 parts by mass or more, still more preferably 65 parts by mass or more, but is preferably 150 parts by mass or less, more preferably 100 parts by mass or less, still more preferably 80 parts by mass or less. When the amount falls within the range indicated above, the effects of the present invention tend to be better achieved.

The rubber composition containing silica preferably further contains a silane coupling agent.

Non-limiting examples of the silane coupling agent include sulfide silane coupling agents such as bis(3-triethoxysilylpropyl)tetrasulfide, bis(2-triethoxysilylethyl)tetrasulfide, bis(4-triethoxysilylbutyl)tetrasulfide, bis(3-trimethoxysilylpropyl)tetrasulfide, bis(2-trimethoxysilylethyl)tetrasulfide, bis(2-triethoxysilylethyl)trisulfide, bis(4-trimethoxysilylbutyl)trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N,N-dimethylthiocarbamoyl tetrasulfide, 2-triethoxysilylethyl-N,N-dimethylthiocarbamoyl tetrasulfide, and 3-triethoxysilylpropyl methacrylate monosulfide; mercapto silane coupling agents such as 3-mercaptopropyltrimethoxysilane and 2-mercaptoethyltriethoxysilane; vinyl silane coupling agents such as vinyltriethoxysilane and vinyltrimethoxysilane; amino silane coupling agents such as 3-aminopropyltriethoxysilane and 3-aminopropyltrimethoxysilane; glycidoxy silane coupling agents such as y-glycidoxypropyltriethoxysilane and y-glycidoxypropyltrimethoxysilane; nitro silane coupling agents such as 3-nitropropyltrimethoxysilane and 3-nitropropyltriethoxysilane; and chloro silane coupling agents such as 3-chloropropyltrimethoxysilane and 3-chloropropyltriethoxysilane. Examples of commercially available silane coupling agents include products of Degussa, Momentive, Shin-Etsu Silicone, Tokyo Chemical Industry Co., Ltd., AZmax. Co., and Dow Corning Toray Co., Ltd. These silane coupling agents may be used alone or in combinations of two or more. Among these, mercapto silane coupling agents are preferred because the effects of the present invention tend to be better achieved.

Examples of particularly suitable mercapto silane coupling agents include silane coupling agents represented by the formula (S1) below and silane coupling agents containing linking units A and B represented by the formulas (I) and (II), respectively, below. Among these, silane coupling agents containing a linking unit A of formula (I) and a linking unit B of formula (II) are preferred because the effects of the present invention tend to be better achieved.

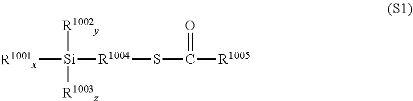

In formula (S1), R¹⁰⁰¹ represents a monovalent group selected from —Cl, —Br, —OR1006, —O(O═)CR¹⁰⁰⁶, —ON ═CR¹⁰⁰⁶R¹⁰⁰⁷, —ON═CR¹⁰⁰⁶R¹⁰⁰⁷, —NR¹⁰⁰⁶R¹⁰⁰⁷, and —(OSiR¹⁰⁰⁶R¹⁰⁰⁷) ₕ (OSiR¹⁰⁰⁶R¹⁰⁰⁷R¹⁰⁰⁸) wherein R¹⁰⁰⁶, R¹⁰⁰⁷, and R¹⁰⁰⁸ may be the same or different and each represent a hydrogen atom or a C1-C18 monovalent hydrocarbon group, and h is 1 to 4 on average; R¹⁰⁰² represents R¹⁰⁰¹, a hydrogen atom, or a C1-C18 monovalent hydrocarbon group; R¹⁰⁰³ represents R¹⁰⁰¹, R¹⁰⁰², a hydrogen atom, or the group: —[O(R¹⁰⁰⁹O)ⱼ]_{0.5}— wherein R¹⁰⁰⁹ represents a C1-C18 alkylene group, and j represents an integer of 1 to 4; R¹⁰⁰⁴ represents a C1-C18 divalent hydrocarbon group; R¹⁰⁰⁵ represents a C1-C18 monovalent hydrocarbon group; and x, y, and z are numbers satisfying the following relationships: x+y+2z=3, 0 5 x≤3, 0≤y≤2, and 0≤z≤1.

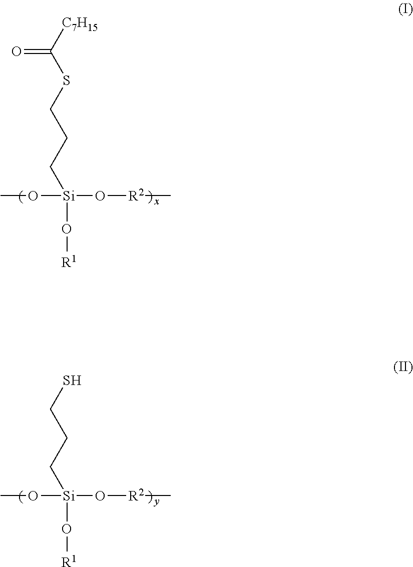

In formulas (I) and (II), x represents an integer of 0 or more; y represents an integer of 1 or more; R¹ represents a hydrogen atom, a halogen atom, a branched or unbranched C1-C30 alkyl group, a branched or unbranched C2-C30 alkenyl group, a branched or unbranched C2-C30 alkynyl group, or the alkyl group in which a terminal hydrogen atom is replaced with a hydroxyl group or a carboxyl group; and R² represents a branched or unbranched C1-030 alkylene group, a branched or unbranched C2-030 alkenylene group, or a branched or unbranched C2-C30 alkynylene group, provided that R¹ and R² may together form a cyclic structure.

Preferably, R¹⁰⁰⁵, R¹⁰⁰⁶, R¹⁰⁰⁷, and R¹⁰⁰⁸ in formula (S1) are each independently selected from the group consisting of C1-C18 linear, cyclic, or branched alkyl, alkenyl, aryl, and aralkyl groups. When R¹⁰⁰² is a C1-C18 monovalent hydrocarbon group, it is preferably selected from the group consisting of linear, cyclic, or branched alkyl, alkenyl, aryl, and aralkyl groups. R¹⁰⁰⁹ is preferably a linear, cyclic, or branched alkylene group, particularly preferably a linear alkylene group. Examples of R¹⁰⁰⁴ include C1-C18 alkylene groups, C2-C18 alkenylene groups, C5-C18 cycloalkylene groups, C6-C18 cycloalkylalkylene groups, C6-C18 arylene groups, and C7-C18 aralkylene groups. The alkylene and alkenylene groups may be linear or branched. The cycloalkylene, cycloalkylalkylene, arylene, and aralkylene groups may each have a functional group such as a lower alkyl group on the ring. Such an R¹⁰⁰⁴ is preferably a C1-C6 alkylene group, particularly preferably a linear alkylene group such as a methylene, ethylene, trimethylene, tetramethylene, pentamethylene, or hexamethylene group.

Specific examples of R¹⁰⁰², R¹⁰⁰⁵, R¹⁰⁰⁶, R¹⁰⁰⁷, and R¹⁰⁰⁸ in formula (S1) include methyl, ethyl, n-propyl, isopropyl, n-butyl, isobutyl, sec-butyl, tert-butyl, pentyl, hexyl, octyl, decyl, dodecyl, cyclopentyl, cyclohexyl, vinyl, propenyl, allyl, hexenyl, octenyl, cyclopentenyl, cyclohexenyl, phenyl, tolyl, xylyl, naphthyl, benzyl, phenethyl, and naphthylmethyl groups.

Examples of the linear alkylene group as R¹⁰⁰⁹ in formula (S1) include methylene, ethylene, n-propylene, n-butylene, and hexylene groups. Examples of the branched alkylene group as R¹⁰⁰⁹ include isopropylene, isobutylene, and 2-methylpropylene groups.

Specific examples of the silane coupling agents of formula (S1) include 3-hexanoylthiopropyltriethoxysilane, 3-octanoylthiopropyltriethoxysilane, 3-decanoylthiopropyltriethoxysilane, 3-lauroylthiopropyltriethoxysilane, 2-hexanoylthioethyltriethoxysilane, 2-octanoylthioethyltriethoxysilane, 2-decanoylthioethyltriethoxysilane, 2-lauroylthioethyltriethoxysilane, 3-hexanoylthiopropyltrimethoxysilane, 3-octanoylthiopropyltrimethoxysilane, 3-decanoylthiopropyltrimethoxysilane, 3-lauroylthiopropyltrimethoxysilane, 2-hexanoylthioethyltrimethoxysilane, 2-octanoylthioethyltrimethoxysilane, 2-decanoylthioethyltrimethoxysilane, and 2-lauroylthioethyltrimethoxysilane. These silane coupling agents may be used alone or in combinations of two or more. Among these, 3-octanoylthiopropyltriethoxysilane is particularly preferred.

The linking unit A content of the silane coupling agent containing a linking unit A of formula (I) and a. linking unit B of formula (II) is preferably 30 mol % or more, more preferably 50 mol % or more, but is preferably 99 mol % or less, more preferably 90 mol % or less. The linking unit B content is preferably 1 mol % or more, more preferably 5 mol % or more, still more preferably 10 mol % or more, but is preferably 70 mol % or less, more preferably 65 mol % or less, still more preferably 55 mol % or less. The combined content of the linking units A and B is preferably 95 mol % or more, more preferably 98 mol % or more, particularly preferably 100 mol %.

The linking unit A or B content refers to the amount including the linking unit A or B present at the end of the silane coupling agent, if any. In the case where the linking unit A or B is present at the end of the silane coupling agent, its form is not particularly limited as long as it forms a unit corresponding to formula (I) representing the linking unit A or formula (II) representing the linking unit B.

Examples of the halogen atom for R¹ in formulas (I) and (II) include chlorine, bromine, and fluorine. Examples of the branched or unbranched C1-C30 alkyl group for R¹ include methyl and ethyl groups. Examples of the branched or unbranched C2-C30 alkenyl group for R¹ include vinyl and 1-propenyl groups . Examples of the branched or unbranched C2-C30 alkynyl group for R¹ include ethynyl and propynyl groups.

Examples of the branched or unbranched C1-C30 alkylene group for R² in formulas (I) and (II) include ethylene and propylene groups. Examples of the branched or unbranched C2-C30 alkenylene group for R² include vinylene and 1-propenylene groups. Examples of the branched or unbranched C2-C30 alkynylene group for R² include ethynylene and propynylene groups.

In the silane coupling agent containing a linking unit A of formula (I) and a linking unit B of formula (II) , the total number of repetitions (x+y) consisting of the sum of the number of repetitions (x) of the linking unit A and the number of repetitions (y) of the linking unit B is preferably in the range of 3 to 300.

The amount of the silane coupling agent, if present, per 100 parts by mass of the silica is preferably 3 parts by mass or more, more preferably 5 parts by mass or more, but is preferably 20 parts by mass or less, more preferably 15 parts by mass or less. When the amount falls within the range indicated above, the effects of the present invention tend to be better achieved.

The rubber composition may contain an oil.

Examples of the oil include process oils, vegetable fats and oils, and mixtures thereof. Examples of the process oils include paraffinic process oils, aromatic process oils, and naphthenic process oils. Examples of the vegetable fats and oils include castor oil, cotton seed oil, linseed oil, rapeseed oil, soybean oil, palm oil, coconut oil, peanut oil, rosin, pine oil, pine tar, tall oil, corn oil, rice oil, safflower oil, sesame oil, olive oil, sunflower oil, palm kernel oil, camellia oil, jojoba oil, macadamia nut oil, and tung oil. These oils may be used alone or in combinations of two or more.

Among these, process oils are preferred, with aromatic process oils being more preferred, because the effects of the present invention can be well achieved.

The amount of the oil, if present, per 100 parts by mass of the rubber component is preferably 1 part by mass or more, more preferably 5 parts by mass or more, but is preferably 30 parts by mass or less, more preferably 20 parts by mass or less. When the amount falls within the range indicated above, the effects of the present invention tend to be better achieved.

The rubber composition may contain a resin. Any resin generally used in the tire industry may be used, and examples include rosin-based resins, coumarone indene resins, α-methylstyrene-based resins, terpenic resins, p-t-buthylphenol acetylene resins, acrylic resins, C5 resins, and C9 resins. Examples of commercially available resins include products of Maruzen Petrochemical Co., Ltd., Sumitomo Bakelite Co., Ltd., Yasuhara Chemical Co., Ltd., Tosoh Corporation, Rutgers Chemicals, BASF, Arizona Chemical, Nitto Chemical Co., Ltd., Nippon Shokubai Co., Ltd., JX Energy Corporation, Arakawa Chemical Industries, Ltd., Taoka Chemical Co., Ltd., and Toagosei Co., Ltd. These resins may be used alone or in combinations of two or more.

The amount of the resin, if present, per 100 parts by mass of the rubber component is preferably 1 part by mass or more, more preferably 5 parts by mass or more, but is preferably 30 parts by mass or less, more preferably 20 parts by mass or less. When the amount falls within the range indicated above, the effects of the present invention tend to be better achieved.

The rubber composition may contain a wax.

Non-limiting examples of the wax include petroleum waxes such as paraffin waxes and microcrystalline waxes; naturally-occurring waxes such as plant waxes and animal waxes; and synthetic waxes such as polymers of ethylene, propylene, or the like. These waxes may be used alone or in combinations of two or more. Among these, petroleum waxes are preferred, with paraffin waxes being more preferred.

The wax may be, for example, a product of Ouchi Shinko Chemical Industrial Co., Ltd., Nippon Seiro Co., Ltd., or Seiko Chemical Co., Ltd.

The amount of the wax, if present, per 100 parts by mass of the rubber component is preferably 0. 3 parts by mass or more, more preferably 0.5 parts by mass or more, but is preferably 20 parts by mass or less, more preferably 10 parts by mass or less. When the amount falls within the range indicated above, the effects of the present invention tend to be better achieved.

The rubber composition may contain an antioxidant. Examples of the antioxidant include: naphthylamine antioxidants such as phenyl-α-naphthylamine; diphenylamine antioxidants such as octylated diphenylamine and 4,4′-bis(α,α′-dimethylbenzyl)diphenylamine; p-phenylenediamine antioxidants such as N-isopropyl-N′-phenyl-p-phenylenediamine, N-(1,3-dimethylbutyl)-N′-phenyl-p-phenylenediamine, and N,N′-di-2-naphthyl-p-phenylenediamine; quinoline antioxidants such as 2,2,4-trimethyl-1,2-dihydroquinoline polymer; monophenolic antioxidants such as 2,6-di-t-butyl-4-methylphenol and styrenated phenol; and bis-, tris-, or polyphenolic antioxidants such as tetrakis-[methylene-3-(3′,5′-di-t-butyl-4′-hydroxyphenyl)-propionate]methane. These antioxidants may be used alone or in combinations of two or more. Among these, p-phenylenediamine or quinoline antioxidants are preferred.

The antioxidant may be, for example, a product of Seiko Chemical Co., Ltd., Sumitomo Chemical Co., Ltd., Ouchi Shinko Chemical Industrial Co., Ltd., or Flexsys.

The amount of the antioxidant, if present, per 100 parts by mass of the rubber component is preferably 0.5 parts by mass or more, more preferably 1 part by mass or more, but is preferably 10 parts by mass or less, more preferably 5 parts by mass or less. When the amount falls within the range indicated above, the effects of the present invention tend to be better achieved.

The rubber composition may contain stearic acid. The stearic acid may be a conventional one, and examples include products of NOF Corporation, Kao Corporation, Wako Pure Chemical Industries, Ltd. , and Chiba Fatty Acid Co., Ltd.

The amount of the stearic acid, if present, per 100 parts by mass of the rubber component is preferably 0.5 parts by mass or more, more preferably 1 part by mass or more, but is preferably 10 parts by mass or less, more preferably 5 parts by mass or less. When the amount falls within the range indicated above, the effects of the present invention tend to be better achieved.

The rubber composition may contain zinc oxide.

The zinc oxide may be a conventional one, and examples include products of Mitsui Mining & Smelting Co., Ltd., Toho Zinc Co., Ltd., HakusuiTech Co., Ltd., Seido Chemical Industry Co., Ltd., and Sakai Chemical Industry Co., Ltd.

The amount of the zinc oxide, if present, per 100 parts by mass of the rubber component is preferably 0.5 parts by mass or more, more preferably 1 part by mass or more, but is preferably 10 parts by mass or less, more preferably 5 parts by mass or less. When the amount falls within the range indicated above, the effects of the present invention tend to be better achieved.

The rubber composition may contain sulfur.

Examples of the sulfur include those commonly used in the rubber industry, such as powdered sulfur, precipitated sulfur, colloidal sulfur, insoluble sulfur; highly dispersible sulfur, and soluble sulfur. These types of sulfur may be used alone or in combinations of two or more.

The sulfur may be, for example, a product of Tsurumi Chemical Industry Co., Ltd., Karuizawa Sulfur Co., Ltd., Shikoku Chemicals Corporation, Flexsys, Nippon Kanryu Industry Co., Ltd., and Hosoi Chemical Industry Co., Ltd.

The amount of the sulfur, if present, per 100 parts by mass of the rubber component is preferably 0.1 parts by mass or more, more preferably 0.5 parts by mass or more, but is preferably 10 parts by mass or less, more preferably 5 parts by mass or less, still more preferably 3 parts by mass or less. When the amount falls within the range indicated above, the effects of the present invention tend to be better achieved.

The rubber composition may contain a vulcanization accelerator.

Examples of the vulcanization accelerator include thiazole vulcanization accelerators such as 2-mercaptobenzothiazole, di-2-benzothiazolyl disulfide, and N-cyclohexyl-2-benzothiazylsulfenamide; thiuram vulcanization accelerators such as tetramethylthiuram disulfide (TMTD), tetrabenzylthiuram disulfide (TBzTD), and tetrakis (2-ethylhexyl)thiuram disulfide (TOT-N); sulfenamide vulcanization accelerators such as N-cyclohexyl-2-benzothiazole sulfenamide, N-t-butyl-2-benzothiazolylsulfenamide, N-oxyethylene-2-benzothiazole sulfenamide, and N,N′-diisopropyl-2-benzothiazole sulfenamide; and guanidine vulcanization accelerators such as diphenylguanidine, diorthotolylguanidine, and orthotolylbiguanidine. These vulcanization accelerators may be used alone or in combinations of two or more. Among these, sulfenamide vulcanization accelerators or guanidine vulcanization accelerators are preferred in order to more suitably achieve the effects of the present invention.

The amount of the vulcanization accelerator, if present, per 100 parts by mass of the rubber component is preferably 1 part by mass or more, more preferably 2 parts by mass or more, but is preferably 10 parts by mass or less, more preferably 7 parts by mass or less. When the amount falls within the range indicated above, the effects of the present invention tend to be better achieved.

In addition to the above components, the rubber composition may contain additives commonly used in the tire industry, such as organic peroxides, and fillers such as calcium carbonate, talc, alumina, clay, aluminum hydroxide, and mica. The amount of such additives is preferably 0.1 to 200 parts by mass per 100 parts by mass of the rubber component.

The rubber composition may be prepared, for example, by kneading the components using a rubber kneading machine such as an open roll mill or a Banbury mixer, and then vulcanizing the kneaded mixture.

The kneading conditions are as follows. In a base kneading step of kneading additives other than vulcanizing agents and vulcanization accelerators, the kneading temperature is usually 100 to 180° C., preferably 120 to 170° C.

In a final kneading step of kneading vulcanizing agents and vulcanization accelerators, the kneading temperature is usually 120° C. or lower, preferably 85 to 110° C. The composition obtained after kneading vulcanizing agents and vulcanization accelerators is usually vulcanized by, for example, press vulcanization. The vulcanization temperature is usually 140 to 190° C., preferably 150 to 185° C.

The rubber composition is for use in tire treads. For use in a tread consisting of a cap tread and a base tread, the rubber composition can be suitably used in the cap tread.

The pneumatic tire of the present invention may be produced using the rubber composition by usual methods.

Specifically, the unvulcanized rubber composition may be extruded into the shape of a tire component such as a tread and then assembled with other tire components on a tire building machine in a usual manner to build an unvulcanized tire, which may then be heated and pressurized in a vulcanizer to obtain a tire.

The tread of the pneumatic tire may at least partially contain the rubber composition. The entire tread may contain the rubber composition.

The pneumatic tire can be suitably used as, for example, a cold weather tire (winter tire) or an all season tire. The term “cold weather tire” as used herein refers to any tire that is intended to be used at low temperatures and has good performance on ice or snow. Specifically, it conceptually includes any of the following tires: snow tires marked on sidewalls as M+S, M. S, or M&S, and tires for the winter season and/or cold weather sold as winter tires or studless winter tires.

### EXAMPLES

The present invention will be specifically described below with reference to, but not limited to, examples.

The chemicals used in examples and comparative examples are listed below.

SBR 1: modified SBR prepared in Production Example 1 below (styrene content: 30% by mass, vinyl content: 40% by mass, Mw: 150,000, extender oil content: 25 parts by mass per 100 parts by mass of rubber solids)

SBR 2: modified SBR prepared in Production Example 2 below (styrene content: 40% by mass, vinyl content: 30% by mass, Mw: 100,000, extender oil content: 25 parts by mass per 100 parts by mass of rubber solids)

SBR 3: modified SBR prepared in Production Example 3 below (styrene content : 20% by mass, vinyl content: 50% by mass, Mw: 200,000)

BR 1: modified BR prepared in Production Example 4 below (cis content: 38% by mass, vinyl content: 13% by mass, Mw: 400,000)

BR 2: BR150B (cis content: 97% by mass, vinyl content: 0.7% by mass, Mw: 500,000) available from Ube Industries, Ltd.

Carbon black: DIABLACK N220 (N₂SA: 114 m²/g) available from Mitsubishi Chemical Corporation

Silica 1: ULTRASIL VN3 (N₂SA: 175 m²/g) available from Degussa

Silica 2: ULTRASIL 9000GR (N₂SA: 240 m²/g) available from Degussa

Silane coupling agent 1: Si266 (bis(3-triethoxysilyl-propyl)disulfide) available from Degussa

Silane coupling agent 2: NXT (3-octanoylthiopropyl-triethoxysilane) available from Momentive

Silane coupling agent 3: NXT-Z45 available from Momentive, a copolymer of linking units A and B (linking unit A: 55 mol %, linking unit B: 45 mol %)

Oil: DIANA PROCESS PA32 (mineral oil) available from Idemitsu Kosan Co., Ltd.

Sulfur: HK-200-5 (powdered sulfur containing 5% by mass oil) availble from Hosoi Chemical Industry Co., Ltd.

Vulcanization accelerator: NOCCELER CZ (N-cyclohexyl-2-benzothiazolylsulfenamide) available from Ouchi Shinko Chemical Industrial Co., Ltd.

### Production Example 1

A nitrogen-purged autoclave reactor was charged with hexane, 1,3-butadiene, styrene, tetrahydrofuran, and ethylene glycol diethyl ether. Next, bis(diethylamino)-methylviiylsilane and n-butyllithium were added as a solution in cyclohexane and a solution in n-hexane, respectively, to start polymerization.

The copolymerization of 1,3-butadiene and styrene was carried out for three hours at a stirring rate of 130 rpm and a temperature inside the reactor of 65° C. while continuously feeding the monomers into the reactor. The polymer solution thus prepared was then stirred at a stirring rate of 130 rpm, and N-(3-dimethylaminopropyl)acrylamide was added, followed by a reaction for 15 minutes. After completion of the polymerization, 2,6-di-tert-butyl-p-cresol was added to the reaction mixture, followed by removing the solvent by steam stripping. The resulting product was dried on hot rolls adjusted at 110° C. to obtain a modified styrene butadiene rubber (SBR 1).

The SBR 1 was mixed with an oil to form a masterbatch before use.

### Production Example 2

A nitrogen-purged autoclave reactor was charged with cyclohexane, tetrahydrofuran, styrene, and 1,3-butadiene. The temperature of the contents in the reactor was adjusted to 20° C., and then n-butyllithium was added to start polymerization. The polymerization was carried out under adiabatic conditions, and the maximum temperature reached 85° C. Once the polymerization conversion rate reached 99%, butadiene was added, followed by further polymerization for five minutes . Then, 3-dimethylaminopropyltrimethoxysilane was added as a modifier, followed by a reaction for 15 minutes. After completion of the polymerization, 2,6-di-tert-butyl-p-cresol was added to the reaction mixture, followed by removing the solvent by steam stripping. The resulting product was dried on hot rolls adjusted at 110° C. to obtain a modified styrene butadiene rubber (SBR 2).

The SBR 2 was mixed with an oil to form a masterbatch before use.

### Production Example 3

A nitrogen-purged autoclave reactor was charged with cyclohexane, tetrahydrofuran, styrene, and 1,3-butadiene. The temperature of the contents in the reactor was adjusted to 20° C., and then n-butyllithium was added to start polymerization. The polymerization was carried out under adiabatic conditions, and the maximum temperature reached 85° C. Once the polymerization conversion rate reached 99%, butadiene was added, followed by further polymerization for five minutes. Then, 3-diethylaminopropyltrimethoxysilane was added as a modifier, followed by a reaction for 15 minutes. After completion of the polymerization, 2, 6-di-tert-butyl-p-cresol was added to the reaction mixture, followed by removing the solvent by steam stripping. The resulting product was dried on hot rolls adjusted at 110° C. to obtain a modified styrene butadiene rubber (SBR 3).

### Production Example 4

To a graduated flask in a nitrogen atmosphere were added 3-(N,N-dimethylamino)propyltrimethoxysilane and then anhydrous hexane to prepare a terminal modifier.

A nitrogen-purged autoclave reactor was charged with cyclohexane, 1,3-butadiene, and diethyl ether. The temperature of the contents in the reactor was adjusted to 60° C., and then n-butyllithium was added, followed by stirring for three hours. Next, a solution of silicon tetrachloride in hexane was added and the mixture was stirred for 30 minutes. Then, the terminal modifier was added, followed by stirring for 30 minutes. To the reaction solution was added a solution of 2,6-tert-butyl-p-cresol in methanol, and the resulting reaction solution was put into a stainless steel vessel containing methanol, followed by collecting aggregates. The aggregates were dried under reduced pressure for 24 hours to obtain a modified polybutadiene rubber (BR 1).

### Examples and Comparative Examples

The chemicals other than the sulfur and the vulcanization accelerator in the formulation amounts indicated in Table 1 were kneaded at 150° C. for five minutes using a 1.7 L Banbury mixer (Kobe Steel, Ltd.) to give a kneaded mixture. Then, the sulfur and vulcanization accelerator were added to the kneaded mixture, and they were kneaded at 80° C. for five minutes using an open roll mill to obtain an unvulcanized rubber composition.

The unvulcanized rubber composition was press-vulcanized at 170° C. for 10minutes to obtain a vulcanized rubber composition.

Separately, the unvulcanized rubber composition was formed into a cap tread shape and assembled with other tire components to build an unvulcanized tire. The unvulcanized tire was press-vulcanized at 170° C. for 10 minutes to prepare a test tire (size: 195/65R15).

The vulcanized rubber compositions and test tires prepared as above were evaluated for the following properties. Table 1 shows the results.

### (Viscoelastic Testing)

The −20° C. E*, 0° C. E*, 0° C. tan δ, and 30° C. tan δ of the vulcanized rubber compositions were measured using a viscoelastic spectrometer VES (Iwamoto Seisakusho Co., Ltd.) under the following conditions:

−20° C. E*: temperature=−20° C., initial strain=10%, dynamic strain=0.5%, frequency=10 Hz;

0° C. E*: temperature=0° C., initial strain=10%, dynamic strain=0.25%, frequency=10 Hz;

0° C. tan δ: temperature=0° C., initial strain=10%, dynamic strain=2.5%, frequency=10 Hz;

30° C. tan δ: temperature=30° C., initial strain=10%, dynamic strain=2%, frequency=10 Hz.

### (Fuel Economy)

The 30° C. tan δ values determined in the viscoelastic testing are expressed as an index (30° C. tan δ index), with. Comparative Example 2 set equal to 100. A higher index means a smaller 30° C. tan δ, indicating better fuel economy.

### (Wet Grip Performance)

The 0° C. tan δ values determined in the viscoelastic testing are expressed as an index (0° C. tan δ index), with Comparative Example 2 set equal to 100. A higher index means a larger 0° C. tan δ, indicating better wet grip performance.

### (Performance on Snow)

A set of test tires of each example were mounted on a front-engine, rear-wheel-drive car of 2000 cc displacement made in Japan. The car was driven on snow in the test site: the Nayoro test track in Hokkaido at an air temperature of −10° C. to −2° C. to evaluate the performance on snow. Specifically, the distance (braking distance on snow) required for the car traveling on snow to stop after the brakes that lock up were applied at 30 km/h was measured and expressed as an index, with Comparative Example 2 set equal to 100. A higher index means a shorter stopping distance, indicating better grip performance on snow.

### (Room Temperature Abrasion Resistance)

The volume loss of samples prepared from the vulcanized rubber compositions was measured with a laboratory abrasion and skid tester (LAT tester) at 23° C., a load of 50 N, a speed of 20 km/h, and a slip angle of 5 degrees and expressed as an index (room temperature LAT index), with Comparative Example 2 set equal to 100. A higher index means a smaller volume loss, indicating better abrasion resistance at 23° C.

(Low temperature abrasion resistance)

The volume loss of the samples was measured under the same conditions as in the measurement of room temperature abrasion resistance, except for changing the measurement temperature to −20° C. The volume losses are expressed as an index (low temperature LAT index), with Comparative Example 2 set equal to 100. A higher index means a smaller volume loss, indicating better abrasion resistance at −20° C.

TABLE 1

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| Formula- | SBR 1 | | 75 | 63 | 56 | 75 | 70 | 56 | 56 | 56 | 56 | 56 |
| tion (parts | SBR 2 | | — | — | — | — | — | — | — | — | — | — |
| by mass) | SBR 3 | | — | — | — | — | — | — | — | — | — | — |
| | BR 1 | | 20 | 20 | 20 | 20 | 20 | 20 | 20 | 20 | 20 | 20 |
| | BR 2 | | 20 | 30 | 35 | 20 | 24 | 35 | 35 | 35 | 35 | 35 |
| | Carbon black | | 10 | 10 | 10 | 10 | 10 | 10 | 10 | 10 | 10 | 10 |
| | Silica 1 | | 65 | 65 | 65 | 65 | 65 | 40 | 30 | 20 | 10 | — |
| | Silica 2 | | — | — | — | — | — | 25 | 35 | 45 | 55 | 65 |
| | Silane coupling agent 1 | | — | — | — | 5 | — | — | — | — | — | — |
| | Silane coupling agent 2 | | 5 | 5 | 5 | — | 5 | 4 | 3 | 2 | 1 | — |
| | Silane coupling agent 3 | | — | — | — | — | — | 1 | 2 | 3 | 4 | 5 |
| | Oil | | 10 | 12 | 14 | 10 | 10 | 14 | 14 | 14 | 14 | 14 |
| | Sulfur | | 1.5 | 1.5 | 1.5 | 1.5 | 1.5 | 1.5 | 1.5 | 1.5 | 1.5 | 1.5 |
| | Vulcanization accelerator | | 2 | 2 | 2 | 2 | 2 | 2 | 2 | 2 | 2 | 2 |
| Evalua- | 0° C. tan δ/30° C. tan δ | | 2.9 | 2.7 | 2.5 | 2.6 | 3.0 | 2.9 | 2.8 | 2.8 | 2.7 | 2.7 |
| tion | \|(−20° C. E*) − (0° C. E*)\| [MPa] | | 40 | 30 | 25 | 40 | 38 | 30 | 27 | 24 | 20 | 15 |
| | −20° C. E* [MPa] | | 60 | 48 | 41 | 62 | 56 | 60 | 65 | 70 | 75 | 80 |
| | 0° C. E* [MPa] | | 20 | 18 | 16 | 22 | 18 | 30 | 38 | 46 | 55 | 65 |
| | Fuel | 30° C. tan δ | 0.13 | 0.13 | 0.13 | 0.15 | 0.12 | 0.12 | 0.13 | 0.14 | 0.15 | 0.16 |
| | economy | 30° C. tan δ | 108 | 108 | 108 | 93 | 117 | 117 | 108 | 100 | 93 | 88 |
| | | index | | | | | | | | | | |
| | Wet grip | 0° C. tan δ | 0.38 | 0.35 | 0.33 | 0.39 | 0.36 | 0.35 | 0.37 | 0.39 | 0.41 | 0.43 |
| | performance | 0° C. tan δ | 105 | 97 | 92 | 108 | 100 | 97 | 103 | 108 | 114 | 119 |
| | | index | | | | | | | | | | |
| | Performance | Index of | 103 | 108 | 113 | 103 | 104 | 104 | 102 | 100 | 98 | 96 |
| | on snow | performance | | | | | | | | | | |
| | | on snow | | | | | | | | | | |
| | Room tempera- | Room | 102 | 105 | 108 | 102 | 103 | 107 | 109 | 111 | 113 | 115 |
| | ture abrasion | temperature | | | | | | | | | | |
| | resistance | LAT index | | | | | | | | | | |
| | Low tempera- | Low | 102 | 107 | 111 | 102 | 104 | 104 | 106 | 108 | 110 | 112 |
| | ture abrasion | temperature | | | | | | | | | | |
| | resisance | LAT index | | | | | | | | | | |

| | | Example | | | | Comparative Example | | | | |
|---|---|---|---|---|---|---|---|---|---|---|
| | | 11 | 12 | 13 | 14 | 1 | 2 | 3 | 4 | 5 |
| Formula- | SBR 1 | 18.8 | 31.3 | 43.8 | 6.25 | 75 | — | 75 | — | 93.8 |
| tion (parts | SBR 2 | — | — | — | — | — | — | — | 75 | — |
| by mass) | SBR 3 | — | — | — | — | — | 60 | — | — | — |
| | BR 1 | 20 | 20 | 20 | 20 | 20 | 20 | — | 20 | 20 |
| | BR 2 | 65 | 55 | 45 | 75 | 20 | 20 | 40 | 20 | 5 |
| | Carbon black | 10 | 10 | 10 | 10 | 75 | 10 | 10 | 10 | 10 |
| | Silica 1 | 65 | 65 | 65 | 65 | — | 65 | 65 | 65 | 65 |
| | Silica 2 | — | — | — | — | — | — | — | — | — |
| | Silane coupling agent 1 | — | — | — | — | — | — | — | — | — |
| | Silane coupling agent 2 | 5 | 5 | 5 | 5 | 5 | 5 | 5 | 5 | 5 |
| | Silane coupling agent 3 | — | — | — | — | — | — | — | — | — |
| | Oil | 10 | 10 | 10 | 10 | 10 | 25 | 10 | 10 | 10 |
| | Sulfur | 1.5 | 1.5 | 1.5 | 1.5 | 1.5 | 1.5 | 1.5 | 1.5 | 1.5 |
| | Vulcanization accelerator | 2 | 2 | 2 | 2 | 2 | 2 | 2 | 2 | 2 |
| Evalua- | 0° C. tan δ/30° C. tan δ | 1.9 | 2.1 | 2.3 | 1.5 | 2.5 | 2.6 | 2.5 | 2.6 | 3.2 |
| tion | \|(−20° C. E*) − (0° C. E*)\| [MPa] | 15 | 23 | 31 | 13 | 50 | 45 | 50 | 55 | 55 |
| | −20° C. E* [MPa] | 30 | 40 | 50 | 25 | 80 | 70 | 65 | 75 | 78 |
| | 0° C. E* [MPa] | 15 | 17 | 19 | 12 | 30 | 25 | 15 | 20 | 23 |

| | | | | | | | | | | |
|---|---|---|---|---|---|---|---|---|---|---|
| Fuel | 30° C. tan δ | 0.10 | 0.11 | 0.12 | 0.09 | 0.15 | 0.14 | 0.15 | 0.17 | 0.16 |
| economy | 30° C. tan δ | 140 | 127 | 117 | 156 | 93 | 100 | 93 | 81 | 88 |
| | index | | | | | | | | | |
| Wet grip | 0° C. tan δ | 0.19 | 0.23 | 0.28 | 0.18 | 0.38 | 0.36 | 0.38 | 0.45 | 0.51 |
| performance | 0° C. tan δ | 53 | 64 | 77 | 50 | 105 | 100 | 105 | 123 | 142 |
| | index | | | | | | | | | |
| Performance | Index of | 110 | 108 | 106 | 112 | 98 | 100 | 95 | 96 | 97 |
| on snow | performance | | | | | | | | | |
| | on snow | | | | | | | | | |
| Room tempera- | Room | 110 | 108 | 106 | 112 | 100 | 100 | 103 | 108 | 97 |
| ture abrasion | temperature | | | | | | | | | |
| resistance | LAT index | | | | | | | | | |
| Low tempera- | Low | 113 | 110 | 107 | 116 | 99 | 100 | 89 | 91 | 96 |
| ture abrasion | temperature | | | | | | | | | |
| resistance | LAT index | | | | | | | | | |

As shown in Table 1, the examples satisfying relationships (1) and (2) exhibited good abrasion resistance at −20° C., and those with a smaller |(−20° C. E*)−(0° C. E*)| value tended to have better abrasion resistance at −20° C.

The examples also exhibited good abrasion resistance at room temperature (23° C.), good performance on snow, and good fuel economy. Particularly in Examples 1 to 10, all the properties shown in Table 1, including these properties and wet grip performance, were high and well balanced.

1. A pneumatic tire, comprising a tread,
the tread at least partially comprising a tread rubber composition satisfying the following relationships (1) and (2):

|(−20° C. E*)−(0° C. E*)|≤40 [MPa] (1)
wherein the term “−20° C. E*” denotes a complex modulus measured at a temperature of −20° C., an initial strain of 10%, a dynamic strain of 0.5%, and a frequency of 10 Hz, and the term “0° C. E*” denotes a complex modulus measured at a temperature of 0° C., an initial strain of 10%, a dynamic strain of 0.25%, and a frequency of 10 Hz; and
0° C. tan δ/30° C. tan δ≤3.0 (2)
wherein the term “0° C. tan δ” denotes a loss tangent measured at a temperature of 0° C., an initial strain of 10%, a dynamic strain of 2.5%, and a frequency of 10 Hz, and the term “30° C. tan δ” denotes a loss tangent measured at a temperature of 30° C., an initial strain of 10%, a dynamic strain of 2%, and a frequency of 10 Hz.

2. The pneumatic tire according to claim 1,
wherein the |(−20° C. E*)−(0° C. E*)| value in relationship (1) is 30 MPa or less.

3. The pneumatic tire according to claim 2,
wherein the |(−20° C. E*)−(0° C. E*)| value in relationship (1) is 20 MPa or less.

4. The pneumatic tire according to claim 1,
wherein the tread rubber composition comprises styrene butadiene rubber and polybutadiene rubber, and
the styrene butadiene rubber has a styrene content of 25 to 40% by mass and a vinyl content of 40 to 55% by mass.

5. The pneumatic tire according to claim 4,
wherein the polybutadiene rubber is a modified polybutadiene rubber.

6. The pneumatic tire according to claim 1,
wherein the pneumatic tire is a cold weather tire or an all season tire.
